(19) United States
(12) Patent Application Publication
(10) Pub. No.: US 2021/0020202 A1
(43) Pub. Date: Jan. 21, 2021

(54) SYSTEM AND METHOD OF AUGMENTED TIMED METADATA GENERATION, STORAGE AND TIMING RECOVERY

(71) Applicant: Hanhui ZHANG, Clarksburg, MD (US)

(72) Inventor: Hanhui ZHANG, Clarksburg, MD (US)

(21) Appl. No.: 16/914,744

(22) Filed: Jun. 29, 2020

Related U.S. Application Data
(60) Provisional application No. 62/876,709, filed on Jul. 21, 2019.

(51) Int. Cl. G11B 27/34; H04N 7/18; H04N 5/77

(52) U.S. Cl. CPC G11B 27/34; H04N 5/77; H04N 7/181

(57) ABSTRACT

A timed metadata recording system includes: a base station; a Timed Metadata Packets collector (TMDP collector) located inside the base station; a plurality of sensor modules that gather Timed Metadata Packets (TMDPs) and send the TMDPs to the TMDP collector; a Timed Metadata Packets processer (TMDP processor) that generates Timed Metadata Records (TMDRs) and Tagging Message Packets (TMPs) based on the TMDPs collected by the TMDP collector; a plurality of audio sequence generators that convert the TMPs to Coded Audio Waveforms (CAWFs); and a plurality of cameras that record the CAWFs. A method for timed metadata recording is also disclosed.

This application claims priority to U.S. Provisional Patent Application No. U.S. 62/876,709, filed on Jul. 21, 2019, which is incorporated by reference for all purposes as if fully set forth herein.

### BACKGROUND OF THE INVENTION

### Field of the Invention

The present invention relates to system and method of augmented timed metadata generation, storage and timing recovery.

### Discussion of the Related Art

Augmented timed metadata from different sensors may be collected during the video footage of a scene are captured into the media streams by the cameras. The metadata may include sensor data from either the accelerometer, gyroscope, magnetometer and GPS equipped by the camera or from the external sources. The metadata may be correlated to certain time windows or group of video or audio samples within the captured media stream. Together with the video and audio samples captured at the scene, metadata is useful in applications such as auto video tagging, highlight extraction and so on.

Traditionally, the augmented timed metadata packets are muxed to the same media stream with their correlated video and audio samples. Either separated tracks or structured data boxes are created in the media streams to hold the augmented timed metadata information. As an example, GoPro, Inc has published GPMF (Gopro Metadata Format) as the data structure to hold the metadata for the Gopro action camera.

Most common cameras only record video and audio streams, they lack the ability of generating and embedding metadata into the media stream they generate. The current invention presented system and method to use audio signaling to facilitate the collection and storage of the augmented timed metadata during the recording of the media stream and synchronizing the stored metadata with the recorded video and audio samples in the post-processing. The system disclosed by current invention adds “augmented timed metadata capability” to the common camera systems and enriched the spectrum of augmented timed metadata can be captured. Simplified term “timed metadata” will be used to refer the “augmented timed metadata” in the later description.

### SUMMARY OF THE INVENTION

In one embodiment, a timed metadata recording system includes: a base station; a Timed Metadata Packets collector (TMDP collector) located inside the base station; a plurality of sensor modules that gather Timed Metadata Packets (TMDPs) and send the TMDPs to the TMDP collector; a Timed Metadata Packets processer (TMDP processor) that generates Timed Metadata Records (TMDRs) and Tagging Message Packets (TMPs) based on the TMDPs collected by the TMDP collector; a plurality of audio sequence generators that convert the TMPs to Coded Audio Waveforms (CAWFs); and a plurality of cameras that record the CAWFs.

In another embodiment, the timed metadata recording system of further includes a Timed Metadata Packets database (TMDP database). The TMDRs are saved in the TMDP database with corresponding relative time offsets from the TMPs.

In another embodiment, the cameras include microphones and media file storages; the microphones pick up the CAWFs; CAWFs are recorded into output audio tracks of the cameras; and the output audio tracks are saved to the media storages.

In another embodiment, the TMDP processor is located inside the base station.

In another embodiment, each of the sensor modules comprises a radio, a computing module, a battery, an accelerometer, a gyroscope, and magnetometers; the accelerometer, the gyroscope, and the magnetometers collect motion data; the computing module generates the TMDPs from the motion data; and the radio transmits the TMDPs to the TMDP collector.

In another embodiment, each of the audio sequence generators comprises a Cyclic Redundancy Check module (CRC module), a Forward Error Correction encoder (FEC encoder), a syncword generator, an audio modulator, and a speaker.

In another embodiment, a method for timed metadata recording includes: gathering Timed Metadata Packets (TMDPs); generating Timed Metadata Records (TMDRs) and Tagging Message Packets (TMPs) based on the TMDPs; saving the TMDRs with corresponding relative time offsets from the TMPs; converting the TMPs to Coded Audio Waveforms (CAWFs); playing the CAWFs; and recording the CAWFs.

In another embodiment, the method for timed metadata further includes: gathering the TMDPs by a plurality of sensor modules; generating the TMDRs and the TMPs based on the TMDPs collected by a Timed Metadata Packets collector (TMDP collector); saving the TMDRs a Timed Metadata Packets database (TMDP database); sending the TMPs to a plurality of audio sequence generators; converting the TMPs to the CAWFs and playing the CAWFs at the audio sequence generators; picking up the CAWFs by microphones of cameras; recording the CAWFs into output audio tracks of the cameras; and saving output audio tracks to media storages of the cameras.

In another embodiment, gathering the TMDPs includes: attaching a plurality of sensor modules to a player; and gathering a set of sensor readings from the sensor modules.

In another embodiment, the player is playing baseball, basketball, football, soccer, hockey, volleyball, tennis, lacrosse, golf, table tennis, or badminton; running; or swimming.

In another embodiment, gathering the TMDPs includes capturing images with a plurality of image sensors and processing the image.

In another embodiment, generating the TMPs based on the TMDPs includes generating base station ID, a scene ID, and a destination camera ID.

In another embodiment, the method of timed metadata recording further includes: identifying sources of the TMDPs; indexing the TMDPs; and timestamping the TMDPs.

In another embodiment, the method of timed metadata further includes: calculating Cyclic Redundancy Check (CRC) checksum and Forward Error Correction (FEC) data block for the TMPs, and attaching a syncword to the TMPs.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, together with the description, illustrate embodiments of the invention and explain the principles of the invention.

In the drawings:

FIG. 1 illustrates an exemplary user case of the disclosed system.

FIG. 2 shows a detailed block diagram of the timed metadata recording system.

FIG. 3A presents a block diagram of an embodiment of sensor module; and FIG. 3B shows the TMDP generation.

FIG. 4 shows an example of the TMDP format.

FIG. 5 shows an example of the TMP format.

FIG. 6A describes the block diagram of the Audio waveform Generator; FIG. 6B shows the frame structure of the data input 608 to the audio modulator 606; and FIG. 6C illustrates the block diagram of the audio waveform detector.

FIG. 7A illustrates the sequence diagram of the timed metadata generation and storage during scene recording using the first embodiment of the system; and FIG. 7B illustrates the sequence diagram of recovering the timed metadata.

FIG. 8A shows examples of the TMP formats; and FIG. 8B shows the associated TMP-Type2 ID 810 of the TMDR used to identify its associated TMP.

FIG. 9A presents a sequence diagram of the overall timed metadata generation and storage procedure during scene recording; and FIG. 9B is a sequence diagram illustrating the post processing procedure of recovering the timing of the metadata from the audio track of the footage media streams.

FIG. 10 shows an example sequence diagram illustrating the data fusion based on recovered the metadata.

### DETAILED DESCRIPTION OF THE ILLUSTRATED EMBODIMENTS

Reference will now be made in detail to embodiments of the present invention, example of which is illustrated in the accompanying drawings.

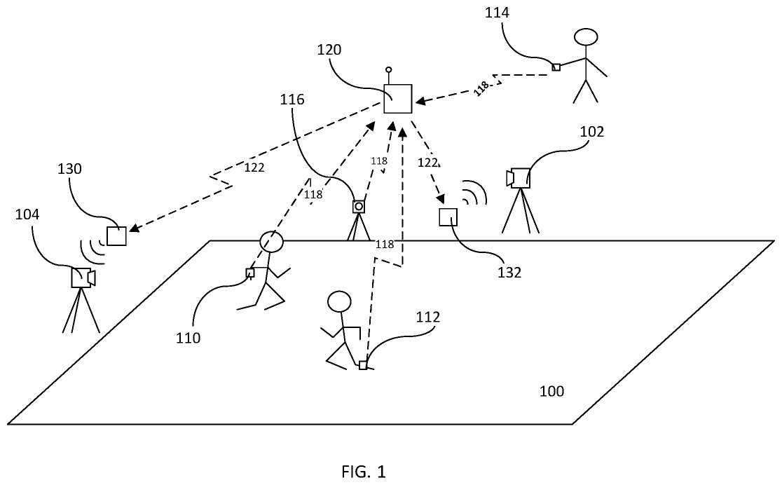

FIG. 1 illustrates an exemplary user case of the disclosed system. A plurality of cameras 102 and 104 record footage of the scene 100. A plurality of sensor modules 110, 112, 114,116 collects data from the scene 100. The collected data are formatted into the Timed Metadata Packets (later referred as TMDP).

The TMDPs are sent to the base station 120 through wired or wireless data links 118 in real time. The base station 120 receives TMDPs and generates the Timed Metadata Record (later referred as TMDR) and save the TMDR to a database.

To synchronize the TMDR with the video and audio streams generated by the cameras, Tagging Message Packets (later referred as TMP) are generated by the base station and distributed to a plurality of Audio waveform Generators (130 and 132) through wired or wireless data links 122, each Audio waveform Generator is within certain distance of a recording camera (102 and 104).

The Audio waveform Generators (130 and 132) convert each received TMP to one Coded Audio Waveform (later referred as CAWF) and play the waveform in real time. The frequency components of the CAWF should be at ultrasound frequency domain or audible frequency domain. The CAWFs are recorded on the audio tracks of the media streams generated by the camera 102 and 104. The time offset of the CAWFs on the audio tracks of the media streams correspond to the generation time of the Timed Metadata with respect of the camera recording timing.

In the post processing, an audio processor can detect and decode the CAWFs and recover the TMP from the audio track. The metadata can be retrieved either from the decoded TMP itself or by associated the TMP with the TMDR saved during the recording stage. Moreover, each timed metadata can be also associate with a group of video frames in the same media stream through standard audio-video synchronization mechanism.

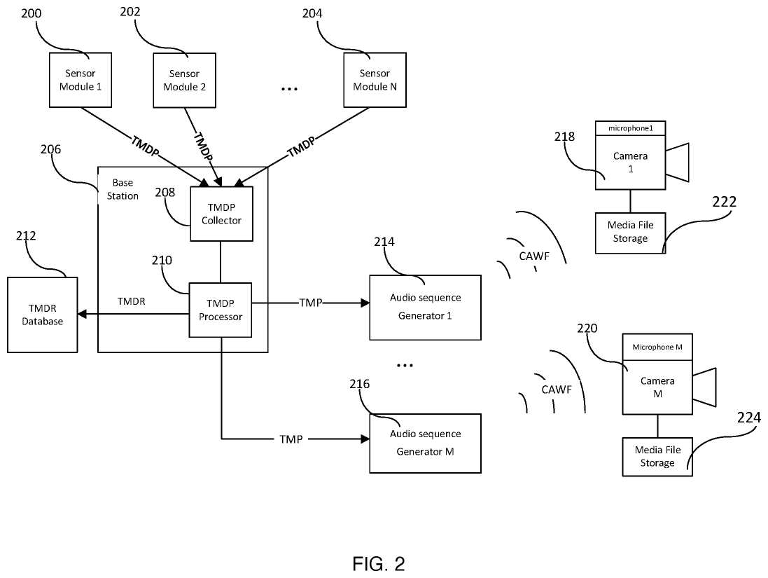

FIG. 2 shows a detailed block diagram of the timed metadata recording system. The TMDP collector 208 in the Base station 206 gathers the TMDPs from a plurality of sensor modules 200, 202 and 204. The TMDP collector 208 may timestamp the incoming TMDPs. The TMDP processor 210 generates the TMDRs based on the information carried by the TMDPs. One TMDR can be generated from a single TMDP, or optionally, can be generated from a group of TMDPs from different sources by evaluate their relationship, such as their senor data type and TMDP their timing order.

The TMDP processor 210 also generate TMPs for the Audio waveform Generators 214 and 216. In one embodiment, the information bits of each TMDP are converted to one TMPs by the TMDP processor 210. In another embodiment, the TMPs are generated as timing reference beacon packet. Each TMP has a unique ID. The information data of TMDPs encapsulated into TMDRs and saved in the TMDR database 212 with their relative time offset from one or more TMPs.

The TMDP processor 210 sends the TMPs to the Audio waveform Generator (214 and 216). A TMP may have single or multiple destination Audio waveform Generators. At the Audio waveform Generator, TMPs are converted to CAWFs and played in real time by a speaker. The CAWFs from Audio waveform Generator 214 are picked up by the microphone of the camera 218 and recorded to its output audio track. The video and audio track are saved to the media storage 222. The CAWFs from Audio waveform Generator 216 are picked up by the microphone of the camera 220 and recorded into its output audio track. The video and audio tracks are saved to the media storage 224.

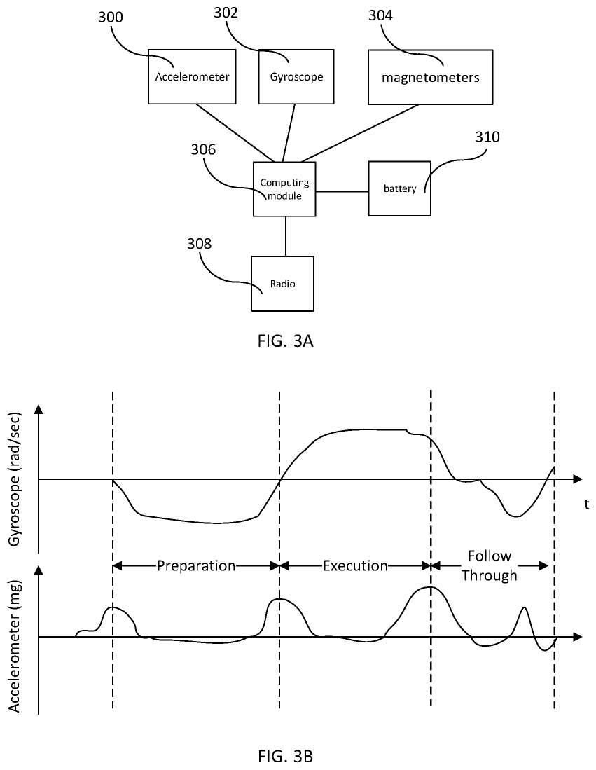

FIG. 3A presents a block diagram of an embodiment of sensor module. The sensor module includes a computing module 306, a battery 310, a radio 308 and a plurality of sensors such as accelerometer 300, the gyroscope 302 and magnetometers 304 and so on. In this embodiment, the sensor modules are made wearable and attached to human body. Various motion data such as moving speed, rotating speed, moving direction and acceleration can be collected by the sensors. The collected sensor measurements are fed into the computing modules 306. The computing module 306 generates the TMDPs from the sensor data. The TMDPs are sent to the base station via the radio 308.

FIG. 3B shows the TMDP generation from a set of sensor readings from accelerometer 300 and gyroscope 302 of the sensor module attached to a player's wrist during a basketball game. The “Preparation-Execution-Follow through” pattern can be identified by certain machine learning algorithms implemented in the computing module 306 and the player's movement can be classified as a ball shooting event. Likewise, other feature movements such as dribbling and passing can also be detected by the computing module 306, and corresponding TMDPs can be generated. Optionally, the raw measurement data from the sensors can be encapsulated into TMDPs.

In another embodiment, sensor modules can be stationary. For example, in a basketball game, a sensor module with an image sensor could be setup to monitor the basketball hoop. Certain image processing algorithm is implemented in the computing module 306 to detect the event of the basketball falling through the hoop. In yet another embodiment, the timed metadata may be collected from user interfaces on smart phone or other input devices. For example, a button-pressing action from the user can be recorded as metadata as the user intention to highlight certain key moment of the scene on demand.

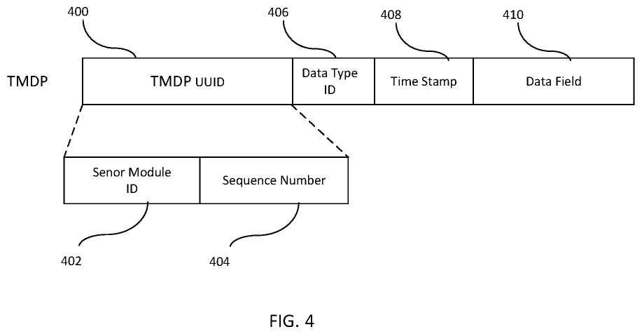

FIG. 4 gives an example of the TMDP format. Each TMDP should have a unique identifiable field namely TMDP UUID 400. The TMDP UUID could be separated into two parts: a “Senor Module ID” field 402 to uniquely identify the source sensor module of the TMDP; and a “Sequence Number” field 404 for the base station to index the TMDPs from a specific sensor module. The “Data Type ID” 406 can be used by the base station to correctly interpret the “Data Field” of the TMDP. A table of available data types should be predefined and share between the sensor modules and the base station. The “Data Field” 410 could be either the raw sensing data such as the measurements from the gyroscopes, accelerometers, magnetometers; Or it could be the activity event detected by the computing module, such as shooting attempts, dribbling and passing. The “Time Stamp” 408 carries the local timer value of the sensor module when the TMDP is generated.

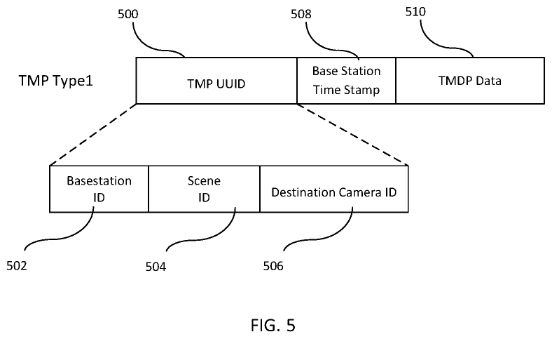

FIG. 5 shows an example of the TMP format of the first embodiment of the system. In this case, each TMDP is directly encapsulated in a TMP. Each TMP is identifiable by its TMP Type-1 ID field 500. The TMP Type-1 ID field may contain three sub-fields: Base station ID 502, Scene ID 504 and the Destination Camera ID 506. The base station ID 502 are used to identify the base station from which the TMP are generated; the Scene ID 504 are generated by the base station to uniquely identify the recorded scene before the system starts recording; The destination camera ID 506 specifies the Audio waveform Generator that current TMP is sent to. Since there is one-to-one mapping between Audio waveform Generators and recording cameras, a TMP will be recorded by the camera matching its destination camera ID 506. The camera ID 506 can contain the IP address or MAC address or any existing identifier of the destination Audio waveform Generator. The TMP Type-1 ID field 500 can be used during the post processing to locate the footage media streams recorded by designated camera at designated scene. the Base Station Time Stamp field 508 contains the local time of the base station when the TMP is sent. The TMDP data field 510 contains the original TMDP information encapsulated in the current TMP.

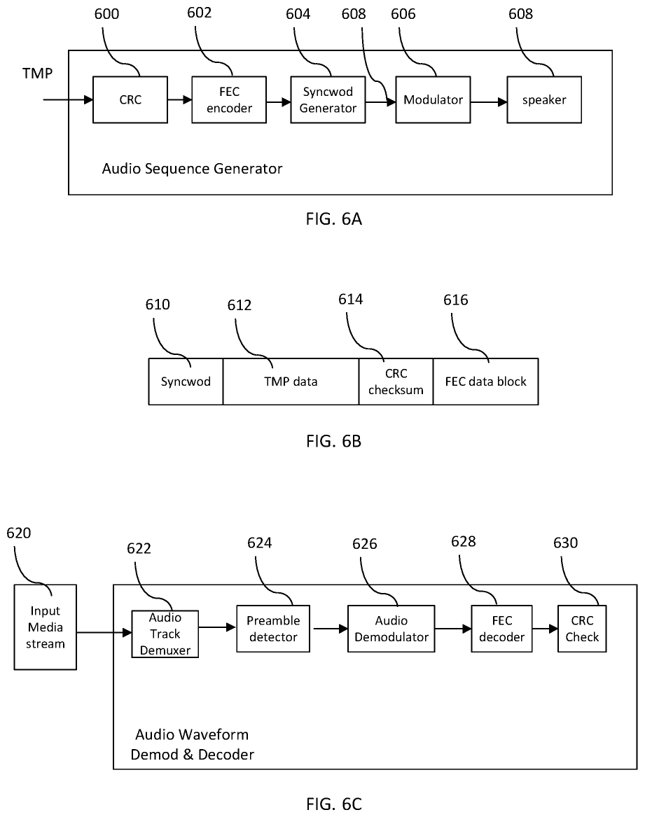

FIG. 6A describes the block diagram of the Audio waveform Generator. The frame structure of the data input 608 to the audio modulator 606 is shown in the FIG. 6B.

The CRC module 600 and FEC encoder module 602 calculate the CRC checksum 614 and Forward Error Correction (FEC) data block 616 for the incoming TMP, the Syncword generator 604 attaches the Syncword 610 to the data frame. The Syncword 610 can be a known data sequence for the detecting and synchronizing the CAWFs from the audio track in the post processing.

The audio modulator 606 modulates said data frame 608 to CAWFs using modulation scheme such as frequency shift keying, phase shift keying, frequency shift chirp modulation, Amplitude modulation or pulse width modulation. All the frequency components of the CAWFs should be within a frequency band centered between 0 Hz and 24 kHz. The speaker 610 amplifies the CAWFs and plays them to the recording camera.

FIG. 6C illustrates the block diagram of the audio waveform detector (audio waveform demod. & decoder), which recover the TMPs from the media streams during the post processing. The audio track demuxer 622 separate the audio track from the input media stream 620. The Syncword detector 624 searches though the audio track to detect the Syncword of the CAWFs. If detected, the audio samples within certain range of the detection point are fed into the Audio Demodulator 626 to recover the raw bits of the TMP. The FEC decoder 628 corrected the demodulation errors and CRC check 630 validate the recovered TMP message.

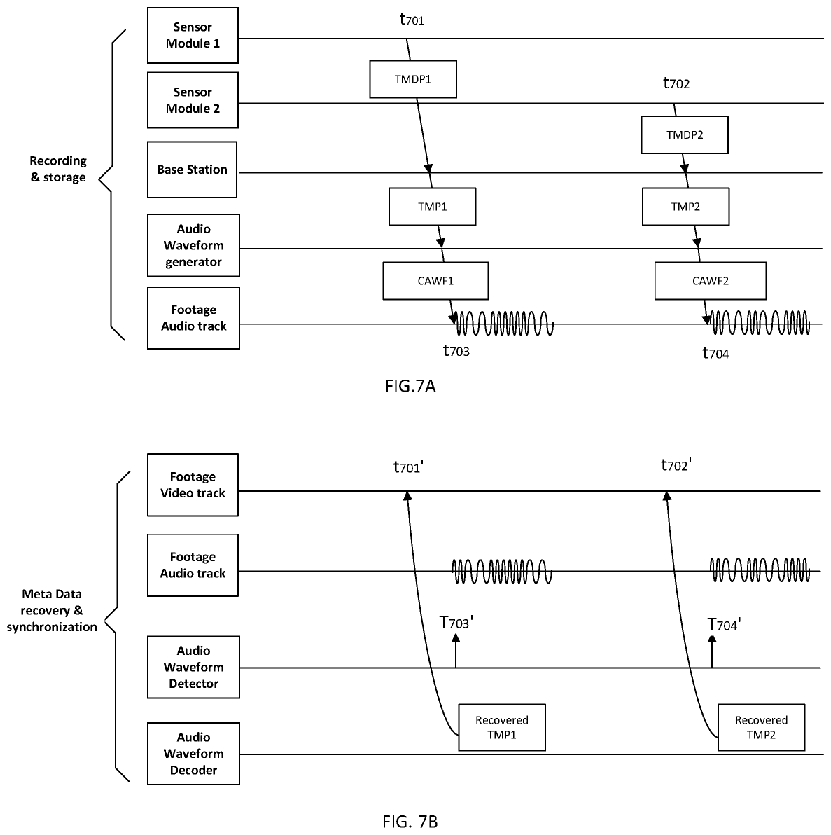

FIG. 7A illustrates the sequence diagram of the timed metadata generation and storage during scene recording using the first embodiment of the system. During the recording period, the camera stores the video and audio footage of the current scene to the video and audio track of the media stream storage. At the same time, TMDPs can be generated by the sensor modules. The sensor module 1 generated a TMDP1 at time t701, the sensor module 2 generated a TMDP2 at time t702. The base station collects the TMDPs and converts them to TMPs in real time, namely TMP1 and TMP2. The TMPs are sent to an Audio waveform Generator paired with the recording camera. The Audio waveform Generator encodes and modulates the TMPs to coded audio waveforms (CAWFs) and plays them from the speaker. The microphone of the recoding camera picks up the CAWFs along with background sound of the scene and save them into the audio track of the media stream the camera is generating. The time offsets of the recorded CAWF1 and CAWF2 with respect of the camera recording timing are t703 and t704 respectively.

FIG. 7B illustrates the sequence diagram of recovering the timed metadata from the audio track and time correlating the timed metadata with the footage media stream using the first embodiment of the system. The audio waveform detector extracts the audio track from the footage media stream and search for syncword of the CAWF, the syncwords are detected at time t703′ and t704′. The audio samples within certain range of the detected syncwords are fed into the audio demodulator and decoder blocks described in FIG. 6C where the original TMPs are recovered. The estimated generating time of the TMDP1 (t701′) and TMDP2 (t702′) with respect to the camera recording timing can be obtained by back off by certain estimated recording delay from t703′ and t704′.

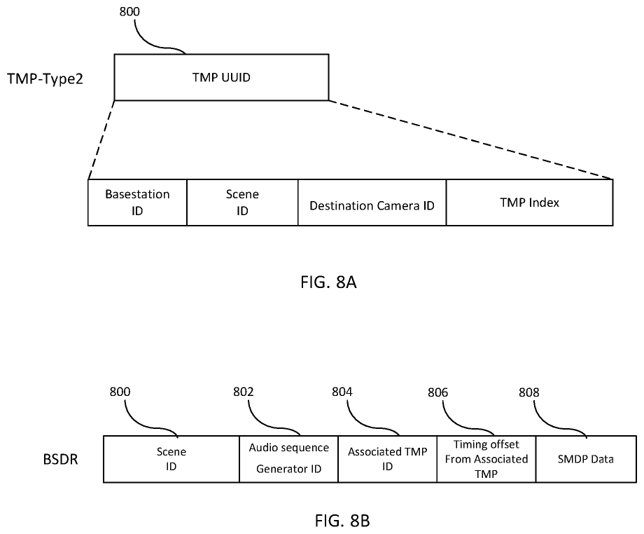

FIG. 8A shows the TMP formats of the second embodiment of the system. The TMP doesn't carry the TMDP data, Instead TMPs are send to the Audio waveform Generator as the timing synchronization beacons. In this case, each TMP only contains a TMP type-2 ID which can uniquely identify each TMP. Apart from the Base station ID, Scene ID and the Destination Camera ID which are already described in the FIG. 5. The TMP contains a TMP UUID field 808 which differentiate every TMP type-2 ID send from the base station during current scene. For example, an index number counting the TMPs sent during current recording scene can be used as the TMP UUID field 808.

In the second embodiment of the system. Each TMDR is uniquely associated with one TMP. Multiply TMDRs can be associated with one TMP. The TMDRs are saved into the TMDR database. As shown in the FIG. 8B, Associated TMP-Type2 ID 810 of the TMDR is used to identify its associated TMP. Whereas field 812 records the offset from the time point which the associated TMP is transmitted to the time point which the TMDP data 808 was received. TMDP data field 814 encapsulates the original TMDP packet information.

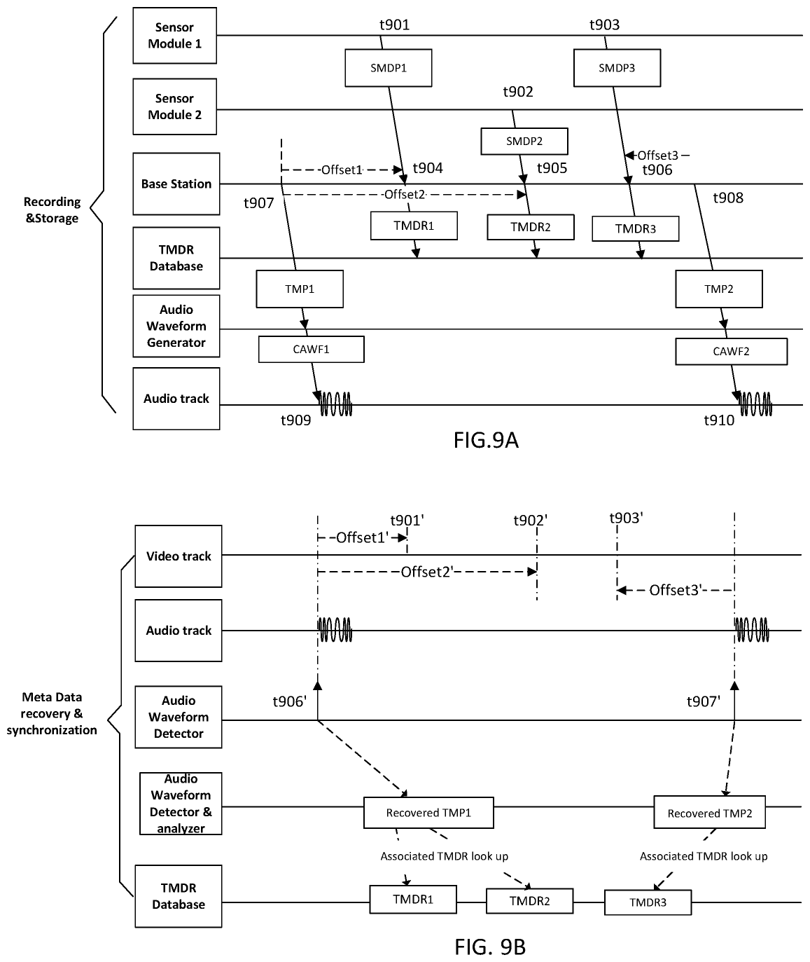

FIG. 9A presents a sequence diagram of the overall timed metadata generation and storage procedure during scene recording using the second embodiment of the system. During the scene recording, the sensor module 1 generates the TMDP1 at time t901 and the TMDP3 at time t903, the sensor module 2 generates the TMDP2 and time t902. The base station receives the TMDP1, TMDP2 and TMDP3 at time t904, t905 and t906 respectively, and generates the TMDR1, TMDR2, TMDR3 according to the TMDR format shown in the FIG. 8B, each TMDR need to be associated with a TMP. In this example, the TMDP1 and TMDP2 are associated with TMP1 which transmitted at time T907, and the TMDP3 are associated with TMP2 which transmitted at time T908. The TMDRs are saved to the TMDR database by the base station.

The Audio waveform Generator converts the TMP1, TMP2 to CAWF1, CAWF2 respectively. the CAWF1 and CAWF2 are played by speaker and get recorded by the footage recording camera into the audio track along with the background sound of the scene at time t909 and t910. The offset1 (t904-t907) is saved in the Timing offset field 812 of the TMDR1; the offset2 (t905-t907) is saved in the Timing offset field 812 of the TMDR2; the offset3 between the (t906-t908) is saved in the Timing offset field 812 of the TMDR3. In this specific case, the offset1 and offset2 have positive value, the offset3 has negative value. All TMDRs generated by the base station are saved into the TMDR database.

The delays (t904-t901), (t905-t902), (t906-t903) can be characterized as the TMDP transmission delay. Different delay may exist between different sensor modules to the base station. For simplicity, we notify all the TMDP transmission delays as Dt. The delays (t909-t907), (t910 to t908) can be characterized as the base station recording delays. The base station recording delays of the CAWFs could be different. For simplicity, we notify all the base station recording delay as Db.

FIG. 9B is a sequence diagram illustrating the post processing procedure of recovering the timing of the metadata from the audio track of the footage media streams using the second embodiment of the system. The Audio waveform detector extracts the audio track from the footage media streams and search the audio track for Syncword of the CAWF, the Syncwords are detected at time t906′ and t907′. The audio samples within certain range around the detected Syncwords are filtered and fed into the audio waveform demodulator and decoder where the original TMPs are recovered. The recovered TMP can be used to look up the associated TMDRs from the TMDR database using the TMP type-2 ID field 800. If the TMDR with same TMP type-2 ID field can be found in the TMDR database, the matched TMDR can be retrieved from the TMDR database and the original timed metadata can be unpacked from the TMDR.

The estimated TMDP generating time of the t901′ (for TMDP1), t902′ (for TMDP2) and t903′ (for TMDP3) with respect to the camera recoding timing can be calculated from the following formula:

t901′=t906′+offset1−Db−Dt

t902′=t906′+offset2−Db−Dt

t903′=t907′+offset3−Db−Dt

After the timed metadata and their timing offset with respect to the recording timing are recovered, the timed metadata can be saved back the original footage media streams. New timed metadata tracks can be created in the footage media streams to hold the recovered timed metadata. Or the timed metadata can be saved to a Sample Group Description box and the association of samples to metadata in Sample to Group boxes. Alternatively, the timed metadata can be used to create highlight clips directly from the footage media streams.

Depending on time order, metadata sources and metadata contents, data fusion can be done during the post processing after the metadata are recovered. Since data from different sources are gathered and analyzed, more complicated activity can be identified.

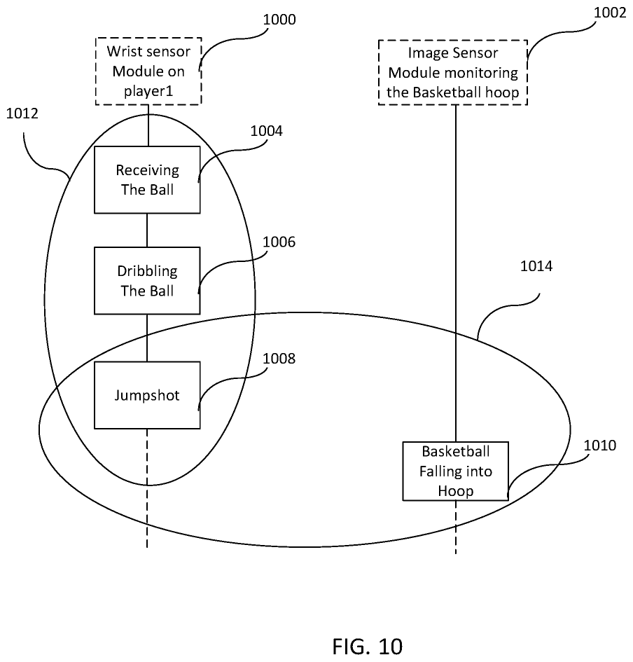

FIG. 10 shows an example sequence diagram illustrating the data fusion based on recovered the metadata. The metadata of 1004 (player1 receiving the ball), 1006 (player1 dribbling the ball), 1008 (player1 jump shot) from the wrist sensor module 1000 attached to the player1 are received. Based on the detected time order of said events in the metadata, the base station could merge the events 404, 406, 408 to a highlight sequence 1012 which represents an offense attempt initiated by the player1. The time span of the highlight sequence 1012 begin at the first event 1004 and end up at the last event 1008 in the sequence.

Similarly, the base station can merge metadata events from different sensor modules into a highlight sequence. If the event (basketball fall through the hoop) 1010 is detected within certain time window after the jump shot event 1008. The highlight sequence 1014 can be formed to represent the scoring of the player1.

The generated highlight sequences data along with their timing and duration information can be saved the original media streams as timed metadata, or they can be used to create the highlight clips from the footage media streams.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A timed metadata recording system comprising:
a base station;
a Timed Metadata Packets collector (TMDP collector) located inside the base station;
a plurality of sensor modules that gather Timed Metadata Packets (TMDPs) and send the TMDPs to the TMDP collector;
a Timed Metadata Packets processer (TMDP processor) that generates Timed Metadata Records (TMDRs) and Tagging Message Packets (TMPs) based on the TMDPs collected by the TMDP collector;
a plurality of audio sequence generators that convert the TMPs to Coded Audio Waveforms (CAWFs); and
a plurality of cameras that record the CAWFs.

2. The timed metadata recording system of claim 1, further comprising a Timed Metadata Packets database (TMDP database),
wherein the TMDRs are saved in the TMDP database with corresponding relative time offsets from the TMPs.

3. The timed metadata recording system of claim 1, wherein the cameras comprise microphones and media file storages; the microphones pick up the CAWFs; CAWFs are recorded into output audio tracks of the cameras; and the output audio tracks are saved to the media storages.

4. The timed metadata recording system of claim 1, wherein the TMDP processor is located inside the base station.

5. The timed metadata recording system of claim 1, wherein each of the sensor modules comprises a radio, a computing module, a battery, an accelerometer, a gyroscope, and magnetometers; the accelerometer, the gyroscope, and the magnetometers collect motion data; the computing module generates the TMDPs from the motion data; and the radio transmits the TMDPs to the TMDP collector.

6. The timed metadata recording system of claim 1, wherein each of the audio sequence generators comprises a Cyclic Redundancy Check module (CRC module), a Forward Error Correction encoder (FEC encoder), a syncword generator, an audio modulator, and a speaker.

7. A method for timed metadata recording comprising:
gathering Timed Metadata Packets (TMDPs);
generating Timed Metadata Records (TMDRs) and Tagging Message Packets (TMPs) based on the TMDPs;
saving the TMDRs with corresponding relative time offsets from the TMPs;
converting the TMPs to Coded Audio Waveforms (CAWFs);
playing the CAWFs; and
recording the CAWFs.

8. The method for timed metadata recording of claim 7, further comprising:
gathering the TMDPs by a plurality of sensor modules;
generating the TMDRs and the TMPs based on the TMDPs collected by a Timed Metadata Packets collector (TMDP collector);
saving the TMDRs a Timed Metadata Packets database (TMDP database);
sending the TMPs to a plurality of audio sequence generators;
converting the TMPs to the CAWFs and playing the CAWFs at the audio sequence generators;
picking up the CAWFs by microphones of cameras;
recording the CAWFs into output audio tracks of the cameras; and
saving output audio tracks to media storages of the cameras.

9. The method of timed metadata recording of claim 7, wherein gathering the TMDPs comprises:
attaching a plurality of sensor modules to a player; and
gathering a set of sensor readings from the sensor modules.

10. The method of timed metadata recording of claim 9, wherein the player is playing baseball, basketball, football, soccer, hockey, volleyball, tennis, lacrosse, golf, table tennis, or badminton; running; or swimming.

11. The method of timed metadata recording of claim 7, wherein gathering the TMDPs comprises capturing images with a plurality of image sensors and processing the image.

12. The method of timed metadata recording of claim 7, wherein generating the TMPs based on the TMDPs comprises generating base station ID, a scene ID, and a destination camera ID.

13. The method of timed metadata recording of claim 7, further comprising:
identifying sources of the TMDPs;
indexing the TMDPs; and
timestamping the TMDPs.

14. The method of timed metadata recording of claim 7, further comprising:
calculating Cyclic Redundancy Check (CRC) checksum and Forward Error Correction (FEC) data block for the TMPs, and attaching a syncword to the TMPs.
